(19) United States
(12) Patent Application Publication
(10) Pub. No.: US 2014/0109727 A1
(43) Pub. Date: Apr. 24, 2014

(54) MULTI-FUNCTIONAL BEVERAGE CONTAINER OPENER

(71) Applicant: Hua Long, Monterey Park, CA (US)

(72) Inventor: Hua Long, Monterey Park, CA (US)

(21) Appl. No.: 14/058,237

(22) Filed: Oct. 19, 2013

Related U.S. Application Data
(60) Provisional application No. 61/716,139, filed on Oct. 19, 2012.

(51) Int. Cl. B67B 7/44

(52) U.S. Cl. CPC B67B 7/44
USPC 81/3.09

(57) ABSTRACT

A multi-functional beverage container opener may include a first bottle opener, a first rotating portion, a second rotating portion, a junction, and a blade. In one embodiment, the first bottle opener may include a first hook and a second hook, creating a space to receive the cap of the beverage. When in use, the cap of the beverage is inserted into the space, and the first hook and second hook are disposed slightly underneath the cap to clamp it, and the user can easily remove the cap by holding the first rotating portion or second rotating portion and lifting the opener.

### CROSS-REFERENCE TO RELATED APPLICATIONS

This application claims priority under 35 U.S.C. §119 (e) to U.S. Provisional Patent Application Ser. No. 61/716,139, filed on Oct. 19, 2012, the entire contents of which are hereby incorporated by reference.

### FIELD OF THE INVENTION

The present invention relates to a beverage container opener, and more particularly to a multifunctional beverage container opener that can be used in different kinds of beverage bottles.

### BACKGROUND OF THE INVENTION

Cap removers with a variety of configurations are known for prying pressed on crown caps from bottles of carbonated beverages and other liquids. There are problems with such devices. For example, the user must search for the cap removers in order to use them to dislodge a cap. The search time is important in establishments such as restaurants, bars, hotels, hospitals, nursing homes and various other business establishments. If the customers are required to wait too long, they will take their business to a competitor with faster service.

Regarding the wine bottle opener, a wine or champagne bottle usually has its bottle mouth stuffed with a cork. To drink wine or champagne in a bottle, a pointed-needle shaped bottle opener is inserted in the cork for uncorking the wine bottle. A conventional bottle opener for uncorking a wine bottle has its upper side provided with a handle and its lower side fixed with a helical awl extending downward from the handle. In use, the helical aw is inserted in the cork stuffed in the bottle mouth of a wine bottle and then the handle is turned around to actuate the helical awl to be helically drilled downward. When drilled into the cork to a substantial depth, the helical aw is pulled outward to remove the cork from the bottle mouth. Since the cork is forcedly pushed tight in the bottle mouth in a way of tight fit in order to prevent the flavor of wine in the bottle from running out and lost or deteriorated; therefore, it must take a lot of exertion to pull the cork out of the bottle mouth 18. In addition, in case the helical awl is drilled into the cork not deep enough, the cork may be impossible to be pulled out and likely to be broken. On the contrary, if the helical awl is drilled excessively deep, chips of the cork may drop to the wine in the wine bottle, thus influencing the quality of the contents. Therefore, there remains a need for a new and improved multifunctional beverage container opener to overcome the problems presented above.

### SUMMARY OF THE INVENTION

It is an object of the present invention to provide a multi-functional beverage container opener to enable the user to easily and efficiently remove a cork from a wine bottle.

It is another object of the present invention to provide a multi-functional beverage container opener to enable the user to easily and quickly remove a cap from a beer or other beverage bottle.

It is a further object of the present invention to provide a multi-functional beverage container opener, so that the user would not waste time to search for different openers for different kinds of bottles.

In one aspect, a multi-functional beverage container opener may include a first bottle opener, a first rotating portion, a second rotating portion, a junction, and a blade. In one embodiment, the first bottle opener may include a first hook and a second hook, creating a space to receive the cap of the beverage. It is noted that the second hook is coupled with a resilient base that may connect to a resilient unit, so that the size of the space becomes adjustable for different sizes of caps. When in use, the cap of the beverage is inserted into the space, and the first hook and second hook are disposed slightly underneath the cap to clamp it, and the user can easily remove the cap by holding the first rotating portion or second rotating portion and lifting the opener. It is noted that the first bottle opener can be stored into the first rotating portion.

In another embodiment, when the opener is used to open a wine bottle, the opener is aligned with the wine bottle and the blade is gradually inserted into the cork. As the second rotating portion rotates, the blade further moves into the cork until the entire blade is inside, and meanwhile the first rotating portion is driven down toward the second rotating portion. The cork can then be lifted and removed from the wine bottle when the user rotates the first rotating portion and the cork will be received in a receiving space in the second rotating portion.

### BRIEF DESCRIPTION OF THE DRAWINGS

FIG. 1 illustrates a schematic view of the multi-functional beverage container opener in the present invention.

FIG. 2 illustrates a schematic view of the multi-functional beverage container opener from another angle in the present invention.

FIG. 3 shows a perspective view of the multi-functional beverage container opener from another angle in the present invention.

FIG. 4 illustrates one embodiment of the multi-functional beverage container opener in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

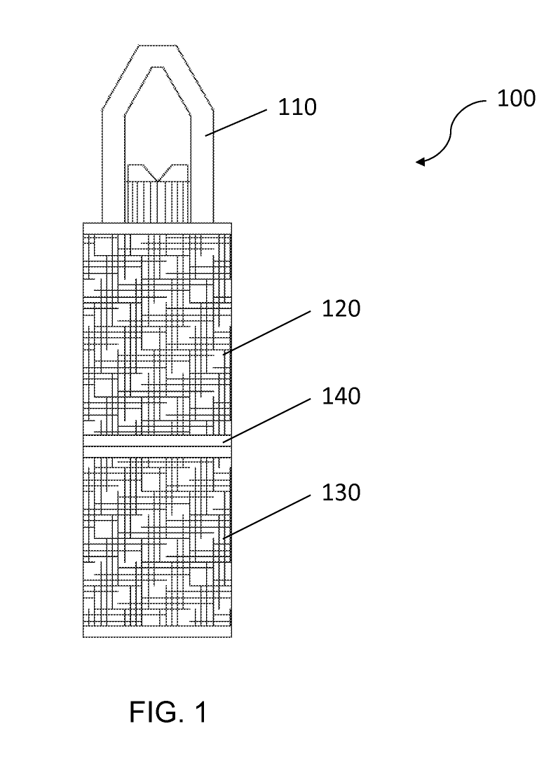

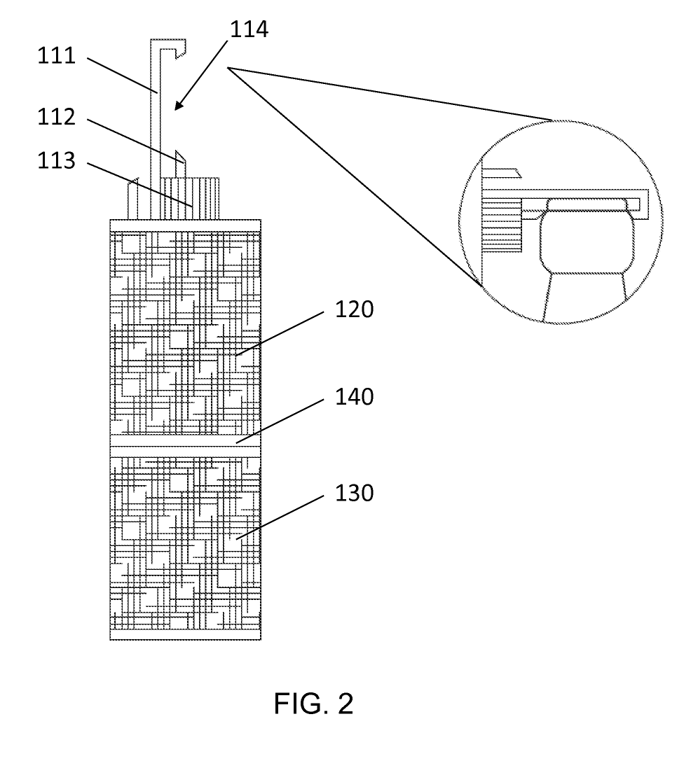

Referring to FIGS. 1 to 4, a multi-functional beverage container opener 100 may include a first bottle opener 110, a first rotating portion 120, a second rotating portion 130, a junction 140, and a blade 150. As shown in FIG. 2, the first bottle opener 110 may include a first hook 111 and a second hook 112, creating a space 114 to receive the cap of the beverage. It is noted that the second hook 112 is coupled with a resilient base 113 that may connect to a resilient unit, so that the size of the space 114 becomes adjustable for different sizes of caps. When in use, the cap of the beverage is inserted into the space 114, and the first hook 111 and second hook 112 are disposed slightly underneath the cap to clamp it, and the user can easily remove the cap by holding the first rotating portion 120 or second rotating portion 130 and lifting the opener 100. It is noted that the first bottle opener 110 can be stored into the first rotating portion 120.

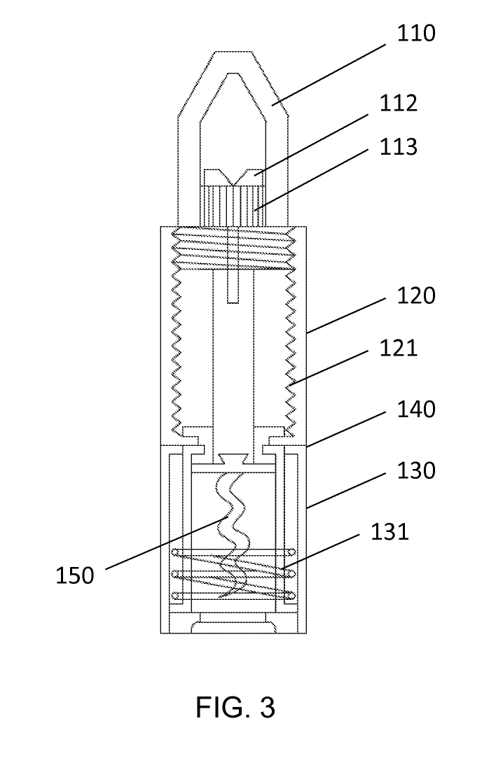

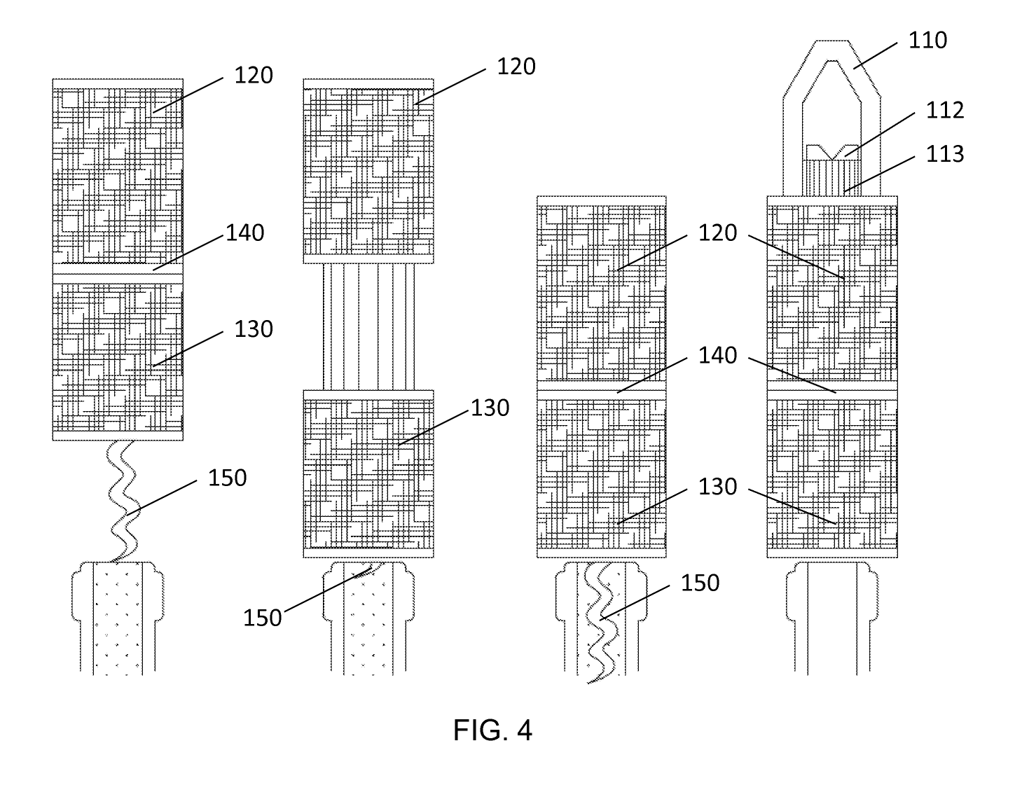

As can be seen in FIG. 3, the beverage container opener 100 may also include inner threads 121 to enable the first rotating portion 120 to rotate. A lower resilient unit 131 is located inside the second rotating unit 130 to enable the blade 150 to move into the cork. As shown in FIG. 4, when the opener 100 is used to open a wine bottle, the opener 100 is aligned with the wine bottle and the blade 150 is gradually inserted into the cork. As the second rotating portion 130 rotates, the blade further moves into the cork until the entire blade is inside, and meanwhile the first rotating portion 120 is driven down toward the second rotating portion 130. The cork can then be lifted and removed from the wine bottle when the user rotates the first rotating portion 120 and the cork will be received in a receiving space in the second rotating portion 130.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A multi-functional beverage container opener comprising a first bottle opener, a first rotating portion, a second rotating portion, a junction, and a blade, wherein the first bottle opener include a first hook and a second hook, creating a space to receive a cap of the beverage, wherein the second hook is coupled with a resilient base connecting to a resilient unit, so that size of the space becomes adjustable for different sizes of caps.

2. The multi-functional beverage container opener of claim 1, wherein the cap of the beverage is inserted into the space, and the first hook and second hook are disposed underneath the cap to clamp the cap, so the user is able to remove the cap by holding the first rotating portion or second rotating portion and lifting the opener.

3. The multi-functional beverage container opener of claim 1, wherein the first bottle opener can be stored into the first rotating portion.

4. The multi-functional beverage container opener of claim 1, further comprising inner threads to enable the first rotating portion to rotate, and a lower resilient unit located inside the second rotating unit to enable the blade to move into a cork of a wine bottle.

5. The multi-functional beverage container opener of claim 4, wherein when the opener is used to open the wine bottle, the opener is aligned with the wine bottle and the blade is gradually inserted into the cork, and as the second rotating portion rotates, the blade further moves into the cork until the entire blade is inside, wherein the first rotating portion is driven down toward the second rotating portion, and the cork is able to be lifted and removed from the wine bottle when the user rotates the first rotating portion.

6. The multi-functional beverage container opener of claim 4, wherein the cork is received in a receiving space in the second rotating portion.
